(19) United States
(12) Patent Application Publication
(10) Pub. No.: US 2026/0332190 A1
(43) Pub. Date: Oct. 22, 2026

(54) FALLBACK MECHANISM FOR CODEBOOK-BASED BEAMFORMING IN AAS

(71) Applicant: Telefonaktiebolaget LM Ericsson (publ), Stockholm (SE)

(72) Inventors: Yongquan QIANG, Ottawa (CA); Hong REN, Kanata (CA); Jianguo LONG, Ottawa (CA)

(21) Appl. No.: 19/117,143

(22) PCT Filed: Oct. 27, 2022
(86) PCT No.: PCT/IB2022/060355

§ 371 Date: Mar. 31, 2025

(51) Int. Cl. H04B 7/04; H04B 7/06

(52) U.S. Cl. CPC H04B 7/04026; H04B 7/063; H04B 7/0639; H04B 7/06958

(57) ABSTRACT

Various embodiments described in the present disclosure provide for a two stage beamforming fallback mechanism for codebook-based beamforming in an Active Antenna System (AAS). In an embodiment, a Pre-coding Matrix Indicator (PMI) report 5 and a Synchronization Signal/Physical Broadcast Channel Resource Indicator (SSBRI) report is received at a base station from a User Equipment device (UE). The base station validates the PMI and the SSBRI in the PMI report and the SSBRI report, and if the PMI and the SSBRI are valid, the base station performs PMI-based UE specific beamforming (UDF) for a communication to the UE. If the PMI is invalid, but the 0 SSBRI is valid, the base station performs SSBRI-based Subsector-specific beamforming (SBF) for the communication to the UE. If the SSBRI is invalid, the base station performs Cell-specific beamforming (CBF) for the communication to the UE.

### TECHNICAL FIELD

The present application relates generally to beamforming in an active antenna system, and more specifically to a fallback mechanism for codebook-based beamforming.

### BACKGROUND

Active Antenna System (AAS) is one of key technologies adopted by 4G LTE and 5G NR to enhance the wireless network performance and capacity by using full dimension Multiple Input Multiple Output (FD-MIMO) or massive MIMO. A typical AAS system consists of two-dimensional antenna elements array with M rows 102, N columns 104 and two polarizations 106 (cross-polarization) as shown in FIG. 1.

Beamforming (BF) is used in AAS to form User Equipment device (UE)-specific beams towards a destination UE, which helps to increase the signal power to the destination UE and reduce the interference to other UEs. A general system model with precoding can be formularized as:

y=H_{DL}Wx+n Eqn. 1

Where H_{DL} is the downlink (DL) channel matrix with dimension of Nᵣ×Nₜ, where Nₜ=2MN is the number of transmitting antennas at a base station (gNB) side. Nᵣ is the number of receiving antennas at UE side. W is the precoding matrix with Nₜ×v. v is the number of transmission layers.

Usually, there are three level of beamforming granularities in terms of beam width, as shown in FIG. 2 which depicts a graph 202 of beam radiation pattern as a function of azimuth.
1) UE-specific BF (UBF) 204
   a. One of the Discrete Fourier Transform (DFT)-based beams is formed to individual UE based on a UE reported Precoding Matrix Indicator (PMI). UBF has the narrowest beam width and highest beamforming gain.
2) Subsector-specific BF (SBF) 206
   a. The cell is split into several subsectors, each of which is covered by one of subsector-specific beams. Subsector-specific beam is selected based on UE reported Synchronization Signal/Physical Broadcast Channel Block Resource Indicator (SSBRI). SBF has a wider beam width and a moderate beamforming gain relative to UBF.
3) Cell-specific BF (CBF) 208
a. The signals are broadcasted in a cell by a common beam. CBF has a cell-wise beam width and lowest beamforming gain relative to UBF and SBF.

### PMI-Based UBF

In PMI-based UBF, the Channel State Information Reference Signal (CSI-RS) resource with a number of ports P_{CSI_RS}=2N₁N₂ is configured together with codebook configuration of (N₁, N₂). PMI is reported by the UE based on a configured CSI-RS resource and codebook.

The precoding matrix with codebook-based approach can be expressed by:

W=Wₚ₂ₐW_{PMI} Eqn. 2

where,
Wₚ₂ₐ is a CSI-RS port-to-antenna mapping matrix with a Nₜ×P_{CSI_RS};
W_{PMI} is a precoding matrix with dimension of P_{CSI_RS}×v;
v is the number of layers; and
W_{PMI} is derived from UE's PMI report, based on the codebook defined in 3GPP TS 38.214 V15.4.0
   Codebook for ½-layer and ¾-layer with P_{CSI_RS}<16

### 1-Layer:

codebookMode = 1

| i_{1,1} | i_{1,2} | i₂ | |
|---|---|---|---|
| 0, 1, ... , N₁O₁ − 1 | 0, ... , N₂O₂ − 1 | 0, 1, 2, 3 | ${W}_{{i}_{1 , 1} , {i}_{1 , 2} , {i}_{2}}^{( 1 )}$ |

$where {W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ] .$

### 2-Layer:

codebookMode = 1

| i_{1,1} | i_{1,2} | i₂ | |
|---|---|---|---|
| 0, 1, ... , N₁O₁ − 1 | 0, ... , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 2 )}$ |

$where {W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ] .$
and the mapping from i_{1,3} to k₁ and k₂ is given in Table 5.2.2.2.1-3.

### 3-Layer (P_{CSI-RS}<16):

codebookMode = 1-2, P_{CSI-RS} < 16

| i_{1,1} | i_{1,2} | i₂ | |
|---|---|---|---|
| 0, 1, ... , N₁O₁ − 1 | 0, ... , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 3 )}$ |

$where {W}_{l , {l}^{′} , m , {m}^{′} . n}^{( 3 )} = \frac{1}{\sqrt{3 {P}_{CSI - RS}}} [ \begin{matrix}{v}_{l , m} & {v}_{{l}^{′} , {m}^{′}} & {v}_{l , m} \\ {φ}_{n} {v}_{l , m} & {φ}_{n} {v}_{{l}^{′} , {m}^{′}} & - {φ}_{n} {v}_{l , m}\end{matrix} ] .$
and the mapping from i_{1,3} to k₁ and k₂ is given in Table 5.2.2.2.1-4.

### 4-Layer (P_{CSI-RS}<16):

codebookMode = 1-2, P_{CSIRS} < 16

| i_{1,1} | i_{1,2} | i₂ | |
|---|---|---|---|
| 0, 1, ... , N₁O₁ − 1 | 0, ... , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 4 )}$ |

$where {W}_{l , {l}^{′} , m , {m}^{′} . n}^{( 4 )} = \frac{1}{\sqrt{4 {P}_{CSI - RS}}} [ \begin{matrix}{v}_{l , m} & {v}_{{l}^{′} , {m}^{′}} & {v}_{l , m} & {v}_{{l}^{′} , {m}^{′}} \\ {φ}_{n} {v}_{l , m} & {φ}_{n} {v}_{{l}^{′} , {m}^{′}} & - {φ}_{n} {v}_{l , m} & - {φ}_{n} {v}_{{l}^{′} , {m}^{′}}\end{matrix} ] .$
and the mapping from i_{1,3} to k₁ and k₂ is given in Table 5.2.2.2.1-4.

O₁, O₂ are oversampling rate for beams in the horizontal and vertical directions, where:

v_{l,m}=vₗ⊗vₘ Eqn. 3

vₗ and vₘ denote horizontal and vertical beams formed by over-sampled DFT vectors with all available antenna ports in horizontal and vertical directions, expressed by:

$${v}_{l} = {[ 1 , {e}^{\frac{j 2 π l}{{N}_{1} {O}_{1}}} , … , {e}^{\frac{j 2 π ( {N}_{1} - 1 ) l}{{N}_{1} {O}_{1}}} ]}^{T} , l = 0 , 1 , … , {N}_{1} {O}_{1} - 1 \qquad Eqn . 4$$

$${v}_{m} = {[ 1 , {e}^{\frac{j 2 π m}{{N}_{2} {O}_{2}}} , … , {e}^{\frac{j 2 π ( {N}_{2} - 1 ) m}{{N}_{2} {O}_{2}}} ]}^{T} , m = 0 , 1 , … , {N}_{2} {O}_{2} - 1 \qquad Eqn . 5$$

where (l,m) and (l′,m′) are beam indexes in horizontal and vertical direction, which can be determined from UE reported PMI (i_{1,1}, i_{1,2}, i_{1,3}, i₂), denoted by:

θₚ=e^{jπp/4}, p=i_{1,3} Eqn. 6

where φₙ is co-phasing factor between two polarizations determined by UE reported inter-polarization co-phasing index i₂ as same as that of codebook with P_{CSI-RS}<16.

### SSBRI-Based SBF

In 3GPP TS 38.214 V15.4.0, to improve Synchronization Signal/Physical Broadcast Channel Block (SSB) coverage, SSB beam sweeping is introduced. That is, instead of broadcasting a single common beam, multiple narrow SSB beams are transmitted in an alternate way in a SSB burst window (~5 ms) with a configurable periodicity (e.g., 20 ms).

An example of SSB beam sweeping with 8 beams is illustrated in FIG. 3. In this case, 8 SSB beams with index from 0 to 7 are beamformed towards different directions alternately in different SSB burst positions 302, 304, 306, and 308. Each of the four SSB burst positions occupies four continuous OFDM symbols in time domain and 20 PRBs in frequency domain.

With multiple SSB beams configured, a gNB can request UE to report SSBRI in each CSI report together with PMI, Rank Indicator (RI), and Channel Quality Indicator (CQI). Once SSBRI is received at the gNB side, the gNB can apply subsector-specific beamforming on Physical Downlink Shared Channel (PDSCH) or Physical Downlink Control Channel (PDCCH) based on SSBRI.

With PMI-based UBF, higher BF gain can be achieved if the received PMI is valid. However, the PMI is not always robust. For example, it may be polluted by inter-cell interference or PDSCH leakage. If an invalid PMI is received at gNB side, the beam is likely directed to a wrong direction. As shown in the graph 402 of FIG. 4, if the desired UE is in direction of beam 404, a wrong PMI with a beam towards the direction of beam 406 could be received at the gNB side. As a result, negative BF gain is experienced.

Traditionally, if an invalid PMI is received, the gNB will fallback directly to a common beam 408, which will degrade the beamforming gain compared with SSB beams as shown in the graph 502 in FIG. 5, in which SSB beams show higher BF gain than common beam 504.

Another problem is that there is no reference for PMI validation at gNB side. When a PMI is received, it is hard to know if it is valid or not.

### SUMMARY

Systems and methods are disclosed for providing a two-stage beamforming fallback mechanism for codebook-based beamforming in an Active Antenna System (AAS). In an embodiment, a Precoding Matrix Indicator (PMI) report and a Synchronization Signal/Physical Broadcast Channel Resource Indicator (SSBRI) report is received at a base station from a User Equipment device (UE). The base station validates the PMI and the SSBRI in the PMI report and the SSBRI report, and if the PMI and the SSBRI are valid, the base station performs PMI-based UE specific beamforming (UDF) for a communication to the UE. If the PMI is invalid, but the SSBRI is valid, the base station performs SSBRI-based Subsector-specific beamforming (SBF) for the communication to the UE. If the PMI and the SSBRI are both invalid, the base station can perform Cell-specific beamforming (CBF) for the communication to the UE. One of the advantages of the disclosed methods and systems is that an intermediate step of SBF is provided instead of immediately falling back to CBF if the PMI is not valid. This can enable the AAS to maintain robust beamforming gain when PMI is not stable.

In an embodiment, method implemented in a base station for providing a fallback mechanism for Codebook Based Beamforming in an AAS, can include receiving, from a User Equipment device (UE) a PMI report and a SSBRI report, determining whether the PMI report and the SSBRI report are valid, determining whether the PMI report and the SSBRI report are valid; in response to the PMI report and the SSBRI report being valid, performing PMI-based UE-specific Beamforming (UBF) for a communication to the UE, in response to the PMI report not being valid, and the SSBRI report being valid, performing Subsector-specific Beamforming (SBF) for the communication to the UE, and in response to the SSBRI report not being valid, performing Cell-specific Beamforming (CBF) for the communication to the UE.

In an embodiment, the method can include determining that the PMI report is valid based on a predefined mapping between PMI information from the PMI report and SSBRI information from the SSBRI report.

In an embodiment, the predefined mapping includes one or more PMI for every SSBRI.

In an embodiment, the method can further include determining whether the SSBRI report is valid based on an amount that SSBRI varies from a reference SSBRI for the UE.

In an embodiment, the reference SSBRI is from a previous SSBRI report.

In an embodiment, the reference SSBRI is a mode filtered SSBRI from a plurality of previous SSBRI reports received during a predefined period of time.

In an embodiment, the method can include providing, to the UE, a request to provide the PMI report and the SSBRI report.

In an embodiment, the request is provided via Channel State Information (CSI) request bits in Downlink Control Information (DCI).

In an embodiment, the PMI reports are received at a first periodicity and the SSBRI reports are received at a second periodicity, wherein the second periodicity is longer than the first periodicity.

In an embodiment, the method can further include determining that the PMI report is valid in response to the SSBRI report being valid, and determining that the PMI report is invalid in response to the SSBRI report being invalid.

In an embodiment, the method can further include determining whether the PMI report is valid based on an amount that PMI varies from a reference PMI for the UE.

In an embodiment, the reference PMI is from a previous PMI report.

In an embodiment, the reference PMI is a mode filtered PMI from a plurality of previous PMI reports received during a predefined period of time.

In an embodiment, provided is a base station configured to providing a fallback mechanism for Codebook Based Beamforming in an AAS, the base station comprising a radio interface and processing circuitry associated with the radio interface, wherein the processing circuitry is configured to cause the base station to receive, from a UE, a PMI, report and a SSBRI report. The processing circuitry is further configured to determine whether the PMI report and the SSBRI report are valid, in response to the PMI report and the SSBRI report being valid, perform PMI-based UE-specific Beamforming, UBF, for a communication to the UE, in response to the PMI report not being valid, and the SSBRI report being valid, perform Subsector-specific Beamforming, SBF, for the communication to the UE, and in response to the SSBRI report not being valid, perform CBF, for the communication to the UE.

In an embodiment, the processing circuitry of the base station is further configured to determine that the PMI report is valid based on a predefined mapping between PMI information from the PMI report and SSBRI information from the SSBRI report.

In an embodiment, the reference SSBRI is from a previous SSBRI report.

In an embodiment, the reference SSBRI is a mode filtered SSBRI from a plurality of SSBRI reports received during a predefined period of time.

In an embodiment, the processing circuitry of the base station is further configured to provide, to the UE, a request to provide the PMI report and the SSBRI report.

In an embodiment, the request is provided via CSI request bits in DCI.

In an embodiment, the PMI reports are received at a first frequency and SSBRI reports are received at a second frequency, wherein the second frequency is lower than the first frequency.

In an embodiment, the processing circuitry is further configured to determine that the PMI report is valid in response to the SSBRI report being valid, and determine that the PMI report is invalid in response to the SSBRI report being invalid.

In an embodiment, the processing circuitry of the base station is further configured to determine whether the PMI report is valid based on an amount that PMI varies from a reference PMI for the UE.

In an embodiment the reference PMI is from a previous PMI report.

In an embodiment, the reference PMI is a mode filtered PMI from a plurality of previous PMI reports received during a predefined period of time.

In an embodiment, provided is a non-transitory computer-readable storage medium that includes executable instructions to cause a processor device of a network node to receive, from a UE, a PMI report, and a SSBRI report. The processing circuitry is further configured to determine whether the PMI report and the SSBRI report are valid, in response to the PMI report and the SSBRI report being valid, perform PMI-based UE-specific Beamforming, UBF, for a communication to the UE, in response to the PMI report not being valid, and the SSBRI report being valid, perform Subsector-specific Beamforming, SBF, for the communication to the UE, and in response to the SSBRI report not being valid, perform Cell-specific Beamforming, CBF, for the communication to the UE.

In an embodiment, the instructions can further cause the processor device to determine that the PMI report is valid based on a predefined mapping between PMI information from the PMI report and SSBRI information from the SSBRI report.

In an embodiment, the instructions can further cause the processor device to determine whether the SSBRI report is valid based on an amount that SSBRI varies from a reference SSBRI for the UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary two-dimensional antenna element array;

FIG. 2 illustrates an exemplary graph depicting beamforming granularities in terms of beam width;

FIG. 3 illustrates exemplary Synchronization Signal/Physical Broadcast Channel Block (SSB) beam sweeping;

FIG. 4 illustrates an exemplary graph depicting an invalid precoding matrix indicator and negative beamforming gain;

FIG. 5 illustrates an exemplary graph depicting beamforming gain of SSB beams over a common beam;

FIG. 6 illustrates an exemplary message sequencing chart and methodology for providing a fallback mechanism for Codebook Based Beamforming in an Active Antenna System (AAS) according to some embodiments of the present disclosure;

FIG. 7 illustrates one example of a cellular communications system according to some embodiments of the present disclosure;

FIG. 8 is a schematic block diagram of a radio access node according to some embodiments of the present disclosure;

FIG. 9 is a schematic block diagram that illustrates a virtualized embodiment of the radio access node of FIG. 8 according to some embodiments of the present disclosure;

FIG. 10 is a schematic block diagram of the radio access node of FIG. 8 according to some other embodiments of the present disclosure;

FIG. 11 is a schematic block diagram of a User Equipment device (UE) according to some embodiments of the present disclosure; and

FIG. 12 is a schematic block diagram of the UE of FIG. 11 according to some other embodiments of the present disclosure.

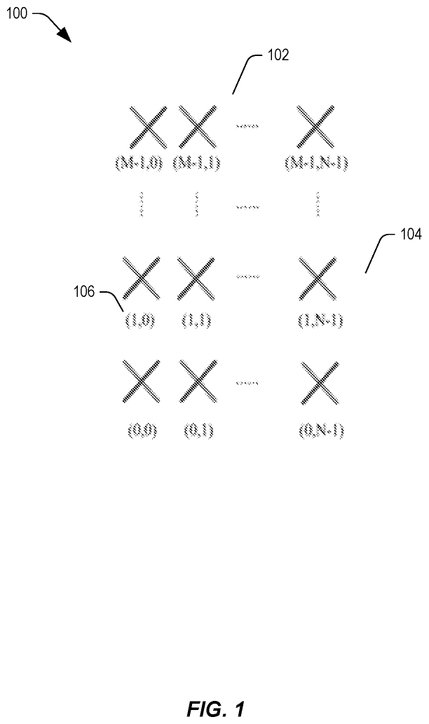

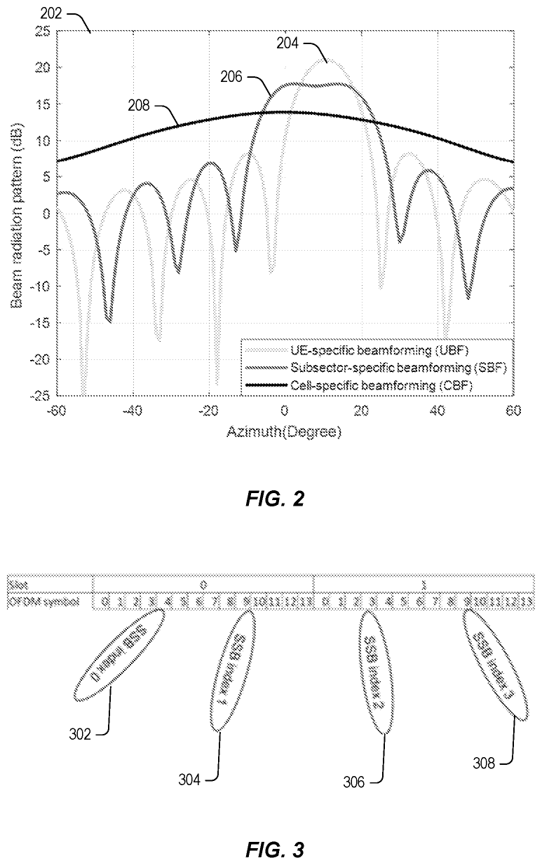

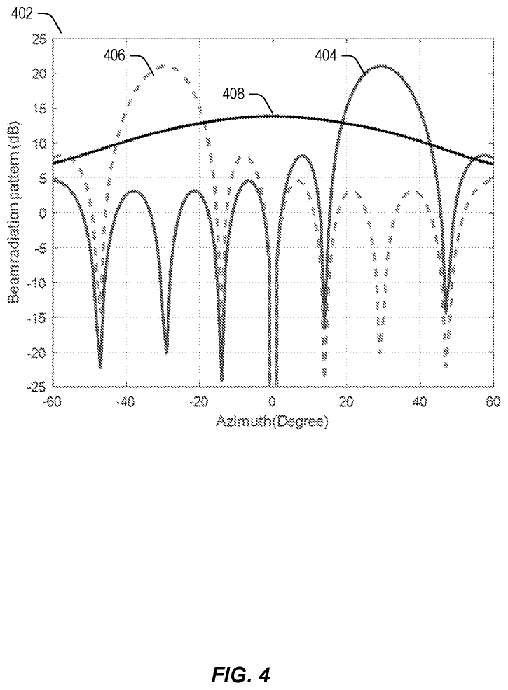

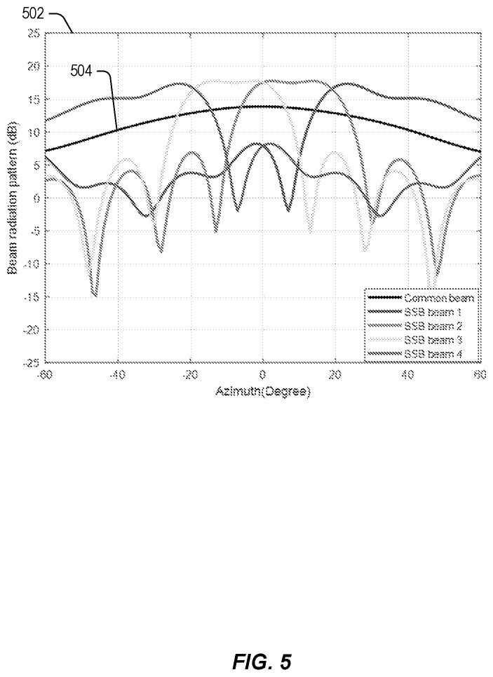

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Various embodiments described in the present disclosure provide for a two-stage beamforming fallback mechanism for codebook-based beamforming in an Active Antenna System (AAS). In an embodiment, a Precoding Matrix Indicator (PMI) report and a Synchronization Signal/Physical Broadcast Channel Resource Indicator (SSBRI) report is received at a base station from a User Equipment device (UE). The base station validates the PMI and the SSBRI in the PMI report and the SSBRI report, and if the PMI and the SSBRI are valid, the base station performs PMI-based UE specific beamforming (UDF) for a communication to the UE. If the PMI is invalid, but the SSBRI is valid, the base station performs SSBRI-based Subsector-specific beamforming (SBF) for the communication to the UE. If the PMI and the SSBRI are both invalid, the base station can perform Cell-specific beamforming (CBF) for the communication to the UE. At least one of the advantages of the embodiments described in the present disclosure, is that robust beamforming gain can be realized, even when PMI is not stable. By providing an intermediate SSBRI-based Subsector-specific beamforming stage, an improvement over CBF can be realized, as long as the SSBRI is stable.

### Overall Procedure

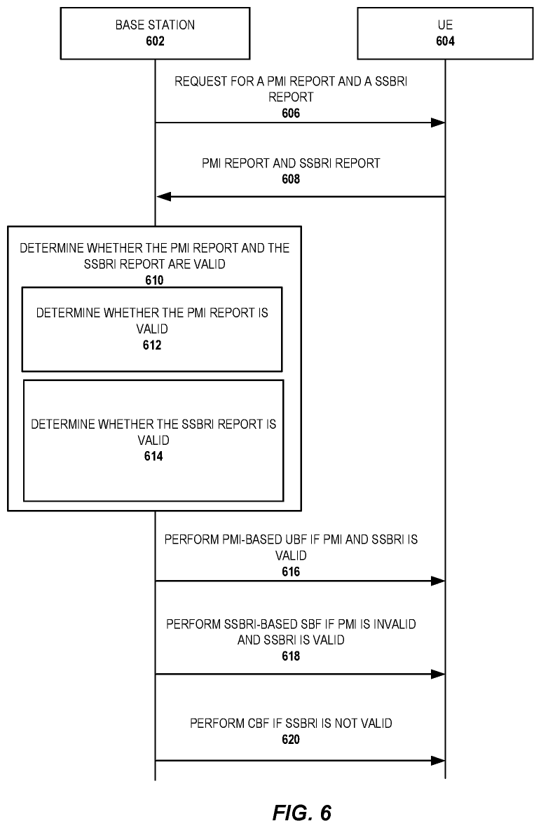

The overall procedure of two-stage beamforming fallback is illustrated in FIG. 6. First, a base station (gNB) 602 requests 606 a UE 604 to report both PMI and SSBRI. The UE 604 provides the PMI and SSBRI in a PMI report and a SSBRI report at 608 Then, PMI and SSBRI validation are performed at gNB side at 610. Based on the results of PMI and SSBRI validation, a beamforming (BF) scheme is selected accordingly for PDSCH and Physical Downlink Control Channel (PDCCH). In a normal case in which both PMI and SSBRI are valid, PMI-based UBF is performed for a communication to the UE at 616. If PMI is invalid however, the BF fallback mechanism is triggered. Instead of directly falling back to CBF, additional stage is introduced. That is, if SSBRI is valid, the SSBRI-based SBF is first selected for the communication 618 to the UE 604. Then, if SSBRI is also invalid, regardless of whether the PMI is valid or not, the base station 602 fallback to CBF for the communication 620 to the UE 604.

Obtaining PMI and SSBRI Report from UE

When needed, at 606 the base station 602 can send a request to the UE 604 to report both PMI and SSBRI via Channel State Information (CSI) request bits in downlink control information (DCI). PMI and SSBRI report can be requested together at same time. Alternatively, since SSBRI is relatively robust, to save CSI feedback overhead, the periodicity of SSBRI report can be longer than that of PMI report. For example, the frequency at which SSBRI is requested and/or provided, could be a lower frequency than the frequency at which PMI is requested and/or provided. At 608, the UE 604 can provide to the base station 602 the PMI and the SSBRI in one or more reports. In an embodiment, the PMI and SSBRI can be included in a measurement report, and in other embodiments, the PMI and SSBRI can be included in respective PMI reports and a SSBRI reports.

Once the PMI and the SSBRI are received from the UE 604, the base station 602 can determine, at 610, whether the PMI or the SSBRI are valid. The following sections discuss the various ways in which the base station 602 can perform the determination of whether the PMI and the SSBRI are valid. In an embodiment, the PMI report can be determined to be valid in response to the SSBRI report being valid, and determining that the PMI report is invalid in response to the SSBRI report being invalid.

### Validating PMI

At 612, the base station 602 can determine whether the PMI and/or the PMI report is valid based on determining that PMI information and SSBRI information are in a predefined mapping table. The idea is to validate PMI based on the robust reference of SSBRI, by establishing an association between PMI and SSBRI. A set of PMIs with beams towards one SSB beam direction is grouped and mapped with the SSBRI.

For example, with a codebook (8,2) and 4 SSB beams, the horizontal PMIs (i11) are ground into 4 groups and mapped to corresponding SSBRI as shown in Table 1. In this case, PMI in set of {17, 18, 19, 20, 21, 22, 23, 25, 26} has beam radiation towards to direction of SSBRI 0. PMI in set of {0, 31, 30, 29, 28, 27} has beam radiation towards to direction of SSBRI 1. PMI in set of {0, 1, 2, 3, 4, 5} has beam radiation towards to direction of SSBRI 2. PMI in set of {6, 7, 8, 9, 10, 11, 12, 13, 14, 15, 16} has beam radiation towards to direction of SSBRI 3.

TABLE 1

| SSBRI | PMI (i11) |
|---|---|
| 0 | {17, 18, 19, 20, 21, 22, 23, 25, 26} |
| 1 | {0, 31, 30, 29, 28, 27} |
| 2 | {0, 1, 2, 3, 4, 5} |
| 3 | {6, 7, 8, 9, 10, 11, 12, 13, 14, 15, 16} |

It's possible that one PMI is associated with multiple SSBRI. In this example, PMI 0 is mapped with both SSBRI 1 and SSBRI 2.

To validate whether the PMI is correct or not, the base station 602 can look up the predefined mapping table between PMI and SSBRI. If received PMI and SSBRI are within the predefined table, the PMI is assumed to be valid. Otherwise, the PMI is taken as invalid. For example, if the base station 602 receives an indication from the UE 604 that the PMI is 17, and the SSBRI is 0, the PMI and SSBRI pair (PMI, SSBRI)=(17,0) is in the predefined mapping table, so that PMI 17 is valid. While, if the PMI and SSBRI pair (17,1) is received, which is not a mapping in the predefined mapping table, the base station 602 determines that the PMI is invalid.

The base station 602 can also determine at step 612 whether the PMI report is valid. In an embodiment, the validity can be based on a PMI variation distance. The variation distance is discussed later in details for SSBRI, and all concepts apply to PMI. Another approach is to assume a PMI is valid if SSBRI is valid, and PMI is invalid if SSBRI is invalid. It is reasonable, since the PMI error is mainly caused by poor UL link quality and decoding at gNB. In that case, if SSBRI is valid, it indicates the UL link quality is acceptable and the probability that the decoding results are correct is large. Thus, we can infer that the PMI is also valid. With this approach, it's better to have a same report periodicity applied on both PMI and SSBRI.

### Validating SSBRI Based on Variation Distance

The base station 602 can determine at step 614 whether the SSBRI report is valid. In an embodiment, the validity can be based on an SSBRI variation distance being less than respective threshold variation distances. As an SSB beam is relatively wider than a Discrete Fourier Transform (DFT)-based beam, SSBRI is relatively robust compared with PMI. An SSBRI is assumed to be invalid if its variation distance is more than a threshold. Likewise, a PMI can be assumed to be invalid if its variation distance relative to a reference PMI is more than another threshold. The SSBRI variation distance is a measure of how much the SSBRI changes over a period of time, and can be measured in two ways as following:

### 1) the Variation Distance Between Two Adjacent SSBRIs

The variation distance between two adjacent SSBRIs, or a current SSBRI and a preceding SSBRI can be expressed by:

D=|iₜ−i_{t-T}| Eqn. 7

where:
   |iₜ−i_{t-T}|=min(mod(iₜ−i_{t-T}, L),mod(i_{t-T}−iₜ, L))
iₜ—SSBRI received in current CSI report
i_{t-T}—SSBRI received in previous CSI report with a periodicity of T
L—The total number of SSB beams formed in the cell

If D is more than a predefined threshold variation distance, the received SSBRI iₜ is treated as invalid. For example, if D>1, it means that the SSBRI is jumping beyond the adjacent subsector, which is unlikely to happen physically. The valid SSBRI is most likely fluctuating between two adjacent subsectors with distance of 1.

Because the determination of whether an SSBRI is valid or not is based on a comparison of a current SSBRI to a previous SSBRI, for a first received SSBRI, there is no reference to measure the variation distance. In this case, base station 602 will rely on CBF for the communication to the UE, as the presumption is the SSBRI is invalid.

### 2) the Variation Distance Between Current SSBRI and the Filtered One in Past Window

In this way, instead of using the previous SSBRI (i_{t-T}) in a previous CSI report, a filtered SSBRI in a preceding CSI report window can be used as the reference SSBRI, expressed by:

D=|iₜ−ĩ_{t-NT}| Eqn. 8

For example, a “mode” filter can be used to get the filtered SSBRI that occurs most often in past window, expressed by:

ĩ_{t-NT}=mode([i_{t-T},i_{t-2T}, . . . ,i_{t-NT}]) Eqn. 9

where:
ĩ_{t-NT}—The filtered SSBRI in past CSI report window from t−NT to t−T.
mode(X)—Function to return the most frequent value in vector X.
N—The number of SSBRI reports in the past CSI report window from time slot of t−NT to t−T.
The number of SSBRI reports N for filtering is predefined parameters.

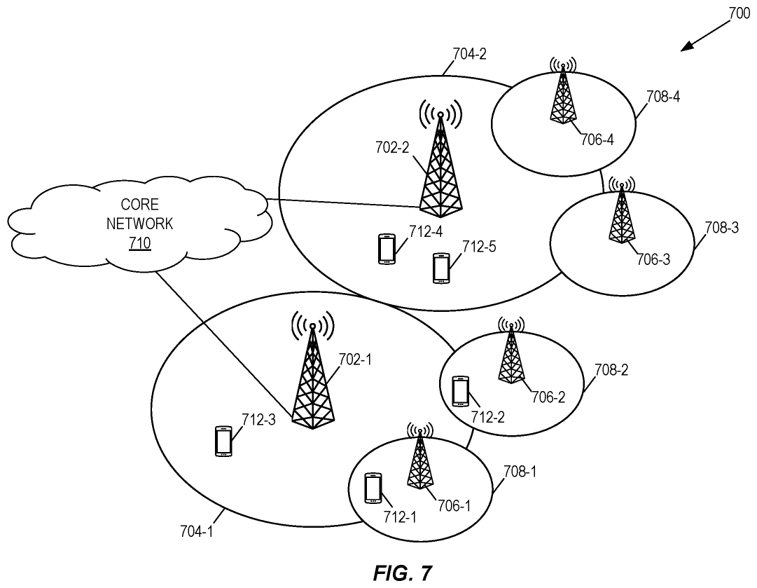

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC. In this example, the RAN includes base stations 702-1 and 702-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 704-1 and 704-2. The base stations 702-1 and 702-2 are generally referred to herein collectively as base stations 702 and individually as base station 702. These base stations 702 can perform similar functions as base station 602 described above in their communications with UEs 712 (e.g., UE 604) Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or RRHs, or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

FIG. 8 is a schematic block diagram of a radio access node 800 according to some embodiments of the present disclosure. Optional features are represented by dashed boxes. The radio access node 800 may be, for example, a base station 702 or 706 or a network node that implements all or part of the functionality of the base station 702 or gNB described herein. As illustrated, the radio access node 800 includes a control system 802 that includes one or more processors 804 (e.g., Central Processing Units (CPUs), Application Specific Integrated Circuits (ASICs), Field Programmable Gate Arrays (FPGAs), and/or the like), memory 806, and a network interface 808. The one or more processors 804 are also referred to herein as processing circuitry. In addition, the radio access node 800 may include one or more radio units 810 that each includes one or more transmitters 812 and one or more receivers 814 coupled to one or more antennas 816. The radio units 810 may be referred to or be part of radio interface circuitry. In some embodiments, the radio unit(s) 810 is external to the control system 802 and connected to the control system 802 via, e.g., a wired connection (e.g., an optical cable). However, in some other embodiments, the radio unit(s) 810 and potentially the antenna(s) 816 are integrated together with the control system 802. The one or more processors 804 operate to provide one or more functions of a radio access node 800 as described herein. In some embodiments, the function(s) are implemented in software that is stored, e.g., in the memory 806 and executed by the one or more processors 804.

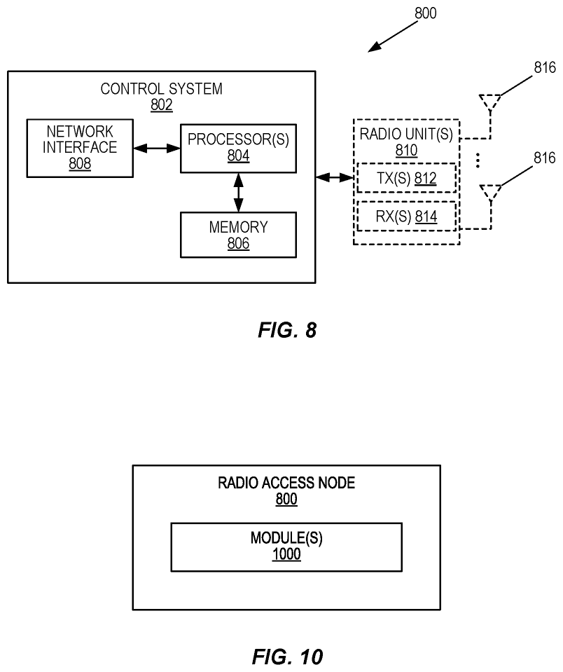

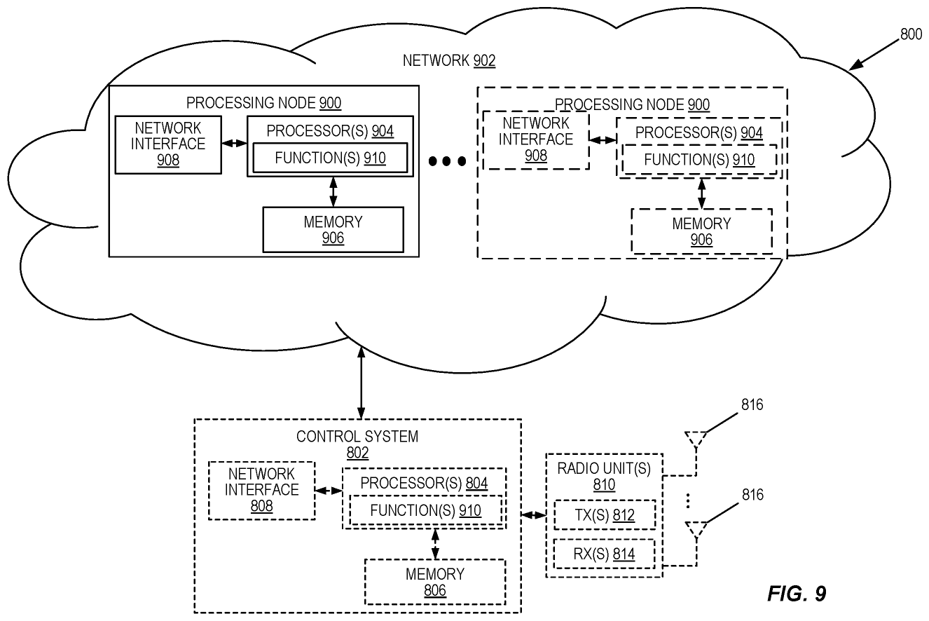

FIG. 9 is a schematic block diagram that illustrates a virtualized embodiment of the radio access node 800 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 800 in which at least a portion of the functionality of the radio access node 800 is implemented as a virtual component(s) (e.g., via a virtual machine(s) executing on a physical processing node(s) in a network(s)). As illustrated, in this example, the radio access node 800 may include the control system 802 and/or the one or more radio units 810, as described above. The control system 802 may be connected to the radio unit(s) 810 via, for example, an optical cable or the like. The radio access node 800 includes one or more processing nodes 900 coupled to or included as part of a network(s) 902. If present, the control system 802 or the radio unit(s) are connected to the processing node(s) 900 via the network 902. Each processing node 900 includes one or more processors 904 (e.g., CPUs, ASICs, FPGAs, and/or the like), memory 906, and a network interface 908.

In this example, functions 910 of the radio access node 800 described herein are implemented at the one or more processing nodes 900 or distributed across the one or more processing nodes 900 and the control system 802 and/or the radio unit(s) 810 in any desired manner. In some particular embodiments, some or all of the functions 910 of the radio access node 800 described herein are implemented as virtual components executed by one or more virtual machines implemented in a virtual environment(s) hosted by the processing node(s) 900. As will be appreciated by one of ordinary skill in the art, additional signaling or communication between the processing node(s) 900 and the control system 802 is used in order to carry out at least some of the desired functions 910. Notably, in some embodiments, the control system 802 may not be included, in which case the radio unit(s) 810 communicate directly with the processing node(s) 900 via an appropriate network interface(s).

In some embodiments, a computer program including instructions which, when executed by at least one processor, causes the at least one processor to carry out the functionality of radio access node 800 or a node (e.g., a processing node 900) implementing one or more of the functions 910 of the radio access node 800 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the radio access node 800 according to some other embodiments of the present disclosure. The radio access node 800 includes one or more modules 1000, each of which is implemented in software. The module(s) 1000 provide the functionality of the radio access node 800 described herein. This discussion is equally applicable to the processing node 900 of FIG. 9 where the modules 1000 may be implemented at one of the processing nodes 900 or distributed across multiple processing nodes 900 and/or distributed across the processing node(s) 900 and the control system 802.

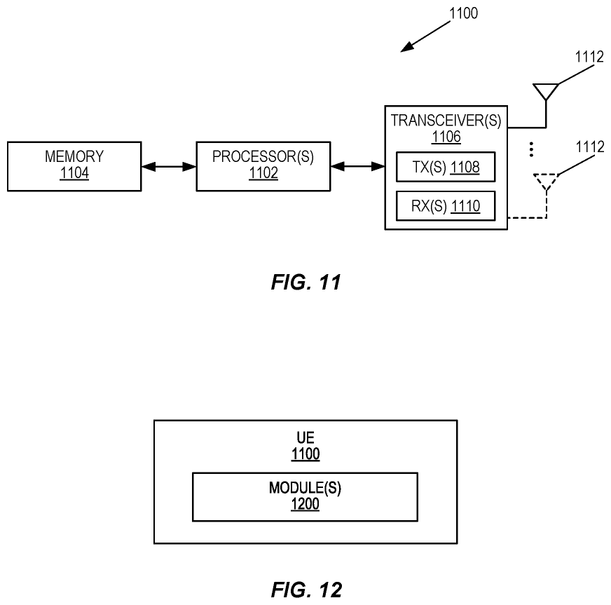

FIG. 11 is a schematic block diagram of a wireless communication device 1100 according to some embodiments of the present disclosure. As illustrated, the wireless communication device 1100 includes one or more processors 1102 (e.g., CPUs, ASICs, FPGAs, and/or the like), memory 1104, and one or more transceivers 1106 each including one or more transmitters 1108 and one or more receivers 1110 coupled to one or more antennas 1112. The transceiver(s) 1106 includes radio-front end circuitry connected to the antenna(s) 1112 that is configured to condition signals communicated between the antenna(s) 1112 and the processor(s) 1102, as will be appreciated by on of ordinary skill in the art. The processors 1102 are also referred to herein as processing circuitry. The transceivers 1106 are also referred to herein as radio circuitry. In some embodiments, the functionality of the wireless communication device 1100 described above may be fully or partially implemented in software that is, e.g., stored in the memory 1104 and executed by the processor(s) 1102. Note that the wireless communication device 1100 may include additional components not illustrated in FIG. 11 such as, e.g., one or more user interface components (e.g., an input/output interface including a display, buttons, a touch screen, a microphone, a speaker(s), and/or the like and/or any other components for allowing input of information into the wireless communication device 1100 and/or allowing output of information from the wireless communication device 1100), a power supply (e.g., a battery and associated power circuitry), etc.

In some embodiments, a computer program including instructions which, when executed by at least one processor, causes the at least one processor to carry out the functionality of the wireless communication device 1100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the wireless communication device 1100 according to some other embodiments of the present disclosure. The wireless communication device 1100 includes one or more modules 1200, each of which is implemented in software. The module(s) 1200 provide the functionality of the wireless communication device 1100 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AAS Active Antenna System
AF Application Function
AMF Access and Mobility Function
AN Access Network
AP Access Point
ASIC Application Specific Integrated Circuit
AUSF Authentication Server Function
BF Beamforming
CBF Cell-specific Beamforming
CPU Central Processing Unit
CQI Channel Quality Indicator
CSI Channel State Information
CSI-RS Channel State Information Reference Signal
DCI Downlink Control Information
DFT Discrete Fourier Transform
DN Data Network
DSP Digital Signal Processor
eNB Enhanced or Evolved Node B
EPS Evolved Packet System
E-UTRA Evolved Universal Terrestrial Radio Access
FD-MIMO Full Dimension Multiple Input Multiple Output
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
PDSCH Physical Downlink Shared Channel
P-GW Packet Data Network Gateway
PMI Precoding Matrix Indicator
PRS Positioning Reference Signal
QoS Quality of Service
RAM Random Access Memory
RAN Radio Access Network
ROM Read Only Memory
RP Reception Point
RRH Remote Radio Head
RTT Round Trip Time
SBF Subsector-specific Beamforming
SCEF Service Capability Exposure Function
SMF Session Management Function
SSBRI Synchronization Signal/Physical Broadcast Channel Resource Block Indicator
TCI Transmission Configuration Indicator
TP Transmission Point
TRP Transmission/Reception Point
UDM Unified Data Management
UE User Equipment
UBF UE-specific Beamforming
UPF User Plane Function

Those skilled in the art will recognize improvements and modifications to the embodiments of the present disclosure. All such improvements and modifications are considered within the scope of the concepts disclosed herein.

1. A method implemented in a base station for providing a fallback mechanism for Codebook Based Beamforming in an Active Antenna System, AAS, the method comprising:
receiving, from a User Equipment device, UE, a Precoding Matrix Indicator, PMI, report, and a Synchronization Signal/Physical Broadcast Channel Resource Block Indicator, SSBRI, report;
determining whether the PMI report and the SSBRI report are valid;
in response to the PMI report and the SSBRI report being valid, performing PMI-based UE-specific Beamforming, UBF, for a communication to the UE;
in response to the PMI report not being valid, and the SSBRI report being valid, performing Subsector-specific Beamforming, SBF, for the communication to the UE; and
in response to the SSBRI report not being valid, performing Cell-specific Beamforming, CBF, for the communication to the UE.

2. The method of claim 1, further comprising:
determining that the PMI report is valid based on a predefined mapping between PMI information from the PMI report and SSBRI information from the SSBRI report.

3. The method of claim 2, wherein the predefined mapping includes one or more PMI for every SSBRI.

4. The method of claim 1, further comprising:
determining whether the SSBRI report is valid based on an amount that SSBRI varies from a reference SSBRI for the UE.

5. The method of claim 4, wherein the reference SSBRI is from a previous SSBRI report.

6. The method of claim 4, wherein the reference SSBRI is a mode filtered SSBRI from a plurality of previous SSBRI reports received during a predefined period of time.

7. The method of claim 1, wherein prior to receiving the PMI report and the SSBRI report, the method comprises:
providing, to the UE, a request to provide the PMI report and the SSBRI report.

8. The method of claim 7, wherein the request is provided via Channel State Information, CSI, request bits in Downlink Control Information, DCI.

9. The method of claim 1, wherein the PMI reports are received at a first periodicity and the SSBRI reports are received at a second periodicity, wherein the second periodicity is longer than the first periodicity.

10. The method of claim 1, further comprising:
determining that the PMI report is valid in response to the SSBRI report being valid, and determining that the PMI report is invalid in response to the SSBRI report being invalid.

11. The method of claim 1, further comprising:
determining whether the PMI report is valid based on an amount that PMI varies from a reference PMI for the UE.

12. The method of claim 11, wherein the reference PMI is from a previous PMI report.

13. The method of claim 11, wherein the reference PMI is a mode filtered PMI from a plurality of previous PMI reports received during a predefined period of time.

14. A base station configured to providing a fallback mechanism for Codebook Based Beamforming in an Active Antenna System, AAS, the base station comprising a radio interface and processing circuitry associated with the radio interface, the processing circuitry being configured to cause the base station to:
receive, from a User Equipment device, UE, a Precoding Matrix Indicator, PMI, report, and a Synchronization Signal/Physical Broadcast Channel Resource Block Indicator, SSBRI, report;
determine whether the PMI report and the SSBRI report are valid;
in response to the PMI report and the SSBRI report being valid, perform PMI-based UE-specific Beamforming, UBF, for a communication to the UE;
in response to the PMI report not being valid, and the SSBRI report being valid, perform Subsector-specific Beamforming, SBF, for the communication to the UE; and
in response to the SSBRI report not being valid, perform Cell-specific Beamforming, CBF, for the communication to the UE.

15. The base station of claim 14, wherein the processing circuitry is further configured to:
determine that the PMI report is valid based on a predefined mapping between PMI information from the PMI report and SSBRI information from the SSBRI report.

16. The base station of claim 15, wherein the predefined mapping includes one or more PMI for every SSBRI.

17. The base station of claim 14, wherein the processing circuitry is further configured to:
determine whether the SSBRI report is valid based on an amount that SSBRI varies from a reference SSBRI for the UE.

18. The base station of claim 17, wherein the reference SSBRI is from a previous SSBRI report.

19. The base station of claim 17, wherein the reference SSBRI is a mode filtered SSBRI from a plurality of SSBRI reports received during a predefined period of time.

20. The base station of claim 14, wherein prior to receiving the PMI report and the SSBRI report, the processing circuitry is further configured to:
provide, to the UE, a request to provide the PMI report and the SSBRI report.

21.-29. (canceled)
